(19) United States
(12) Patent Application Publication
(10) Pub. No.: US 2011/0284039 A1
(43) Pub. Date: Nov. 24, 2011

(54) NOZZLE JET CLEANER FOR DRAINS

(76) Inventor: Lynn Christie, Nova Scotia (CA)

(21) Appl. No.: 13/107,451

(22) Filed: May 13, 2011

Related U.S. Application Data
(60) Provisional application No. 61/345,633, filed on May 18, 2010.

(30) Foreign Application Priority Data
May 18, 2010 (CA) 2,704,692

(51) Int. Cl. B08B 9/032

(52) U.S. Cl. 134/167 C

(57) ABSTRACT

A nozzle jet cleaning apparatus for unplugging drains includes an elongate hose having an outside diameter of ¼ inch and having sufficient resistance to bending and kinking to permit the hose to be fed into a drain passage. A hose coupler is attached to one end of the hose to permit connection thereof with a household source of pressurized water. A cylindrical metal nozzle is mounted inside an end section of the hose at the other end and has a central axial passage extending to a single front aperture located at a front end of the nozzle. The axial passage is of uniform diameter and its front aperture is located at the end of the hose. During use of this cleaning apparatus, the hose is flexible and able to bend along substantially its entire length. An exemplary version of the hose is made of polyamide with polyester yarn reinforcement.

### RELATED APPLICATIONS

This application is a non-provisional application that claims priority benefit of U.S. Provisional Application No. 61/345,633 filed May 18, 2010; as well as Canadian Application No. 2,704,692 filed May 18, 2010; these are hereby incorporated by reference.

### FIELD OF THE INVENTION

This invention is generally directed to plumbing apparatus for unclogging drains including drains for sinks and toilets and more specifically is directed to a nozzle jet cleaning apparatus which uses household water pressure to break up or dislodge obstructions in a drain.

### BACKGROUND OF THE INVENTION

The plugging of drains for toilets and sinks by various forms of obstructions is a common problem for which a variety of devices and chemicals have been developed. The plugging of the waste outlet duct in a toilet is common due to the nature of the trap in the toilet outlet which has a hump over which waste must travel before exiting the toilet. Paper and waste particles can build up along the lower portion of the trap due to insufficient force caused by flushing the toilet to remove waste. This problem has increased recently due to the new water conserving toilets which utilize less water and have less flushing power. The blocking of a toilet outlet can also commonly be caused by the inadvertent dropping of a foreign object into the toilet water, this object becoming caught in the trap.

A variety of tools have been developed to unclog toilet outlets and other drains. For example, a toilet plunger having an elongate rigid handle and a flexible plunging head can be used and is commonly kept in a household. This device relies upon alternating suction and pressure to dislodge the obstruction in the outlet duct of the toilet.

Another common type of toilet clearing device is an auger or snake which generally includes an elongated spring having an outer lead end and an inner end coiled within a crank device. To operate this device, the crank is turned and the spring is released from the crank device to lengthen the outer lead end. The user must position the lead end of the spring just inside the outlet duct of the toilet and use the crank to push the lead end past the trap and over the hump in the outlet. Such devices can be rather cumbersome and difficult to control and they require a substantial amount of physical effort on the part of the user. They can also cause damage to plumbing.

Another known type of drain clearing device employs water pressure to dislodge the obstruction or the material that is caught in the trap. For example, U.S. Pat. No. 5,253,664 issued Oct. 19, 1993 describes a fluid jet cleaning system that includes an elongated flexible hose that can be coupled at one end to a source of pressurized water. The other end contains a jet nozzle assembly having a head with an ejector opening for discharging a high velocity jet stream for dislodging collected debris and a rotatable spinner device containing tangential openings for emitting additional jet streams. However the spinner device could become jammed or its openings could become plugged. In addition the provision of more than one outlet opening in the nozzle assembly has the effect of reducing the amount of pressure in the water streams from the nozzle head.

There is a need for an improved nozzle jet cleaning apparatus for unplugging drains and which can employ a household source of pressurized water. In particular there is a need for such an apparatus that employs an elongate flexible hose having a relatively small diameter so as to permit easy insertion into the drain while at the same time the hose is capable of having sufficient resistance to bending and kinking to allow it to be fed into the drain opening and further into the drain passage.

### SUMMARY OF THE INVENTION

According to one embodiment of the cleaning apparatus of the present disclosure, a nozzle jet cleaning apparatus for unplugging drains includes an elongate flexible hose having an outside diameter of approximately ¼ inch and being made of polyamide with polyester yarn reinforcement, this hose having sufficient resistance to bending and kinking to permit the hose to be fed into a drain passage. The cleaning apparatus includes a hose coupler attached to one end of the hose to permit connection thereof with a source of pressurized water. In addition there is a cylindrical metal nozzle fixedly mounted inside an end section of the hose at the other end located opposite the aforementioned one end. This nozzle has a central axial passage extending the length of the nozzle to a single front aperture located at a front end of the nozzle. The axial passage is of uniform diameter along its length and the front aperture is located at the other end of the hose. During use of this cleaning apparatus, the hose is flexible and able to bend along substantially its entire length.

In an exemplary version of this cleaning apparatus, the hose is constructed so as to have thermoformability and the nozzle is held inside the end section of the hose by a friction fit.

### BRIEF DESCRIPTION OF THE DRAWINGS

These and other aspects of the disclosed nozzle jet cleaning apparatus will become more readily apparent to those having ordinary skill in the art from the following detailed description taken in conjunction with the accompanying drawings.

So that those having ordinary skill in the art to which the present disclosure pertains will more readily understand how to make and use the subject invention, exemplary embodiments thereof will be described in detail herein below with reference to the drawings, wherein:

FIG. 1 is a side view of a coiled nozzle jet cleaning apparatus constructed according to the present disclosure, a portion of the hose being broken away to show indefinite length;

FIG. 2 is a cross-sectional detail view of the nozzle end of the cleaning apparatus of FIG. 1, this view being taken along the line II-II of FIG. 3;

FIG. 3 is an end view of the nozzle end of the cleaning apparatus of FIG. 1;

FIG. 4 is a perspective view of a nozzle jet cleaning apparatus constructed in accordance with the present disclosure being used to unplug a sink drain;

FIG. 5 is a vertical cross-section of a standard toilet bowl showing use of the cleaning apparatus of FIG. 1 to clear a blockage in the toilet bowl trap; and

FIG. 6 is a cross-sectional detail view similar to FIG. 2 but showing an alternate embodiment of the hose end.

### DETAILED DESCRIPTION OF THE PREFERRED EMBODIMENTS

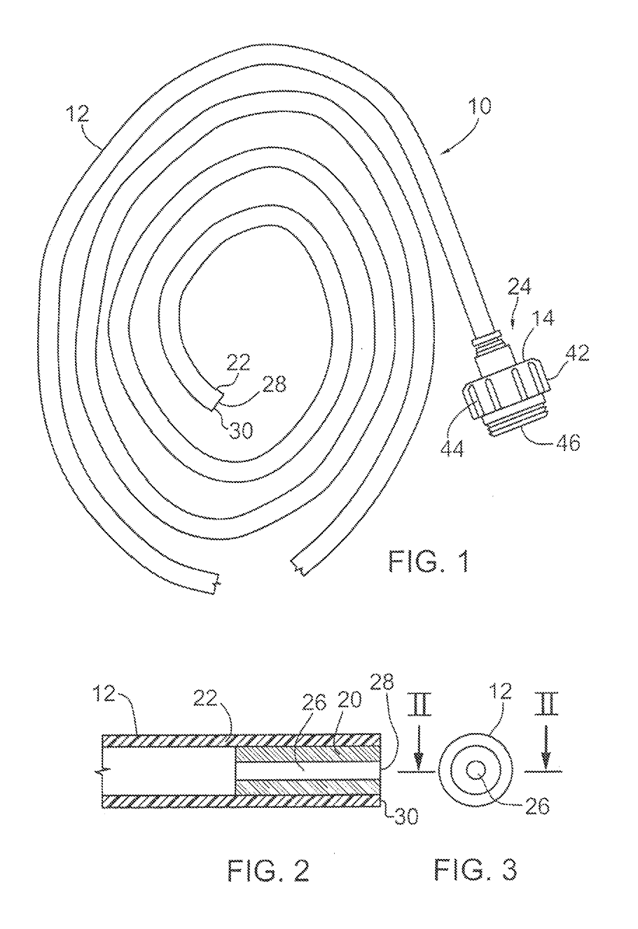

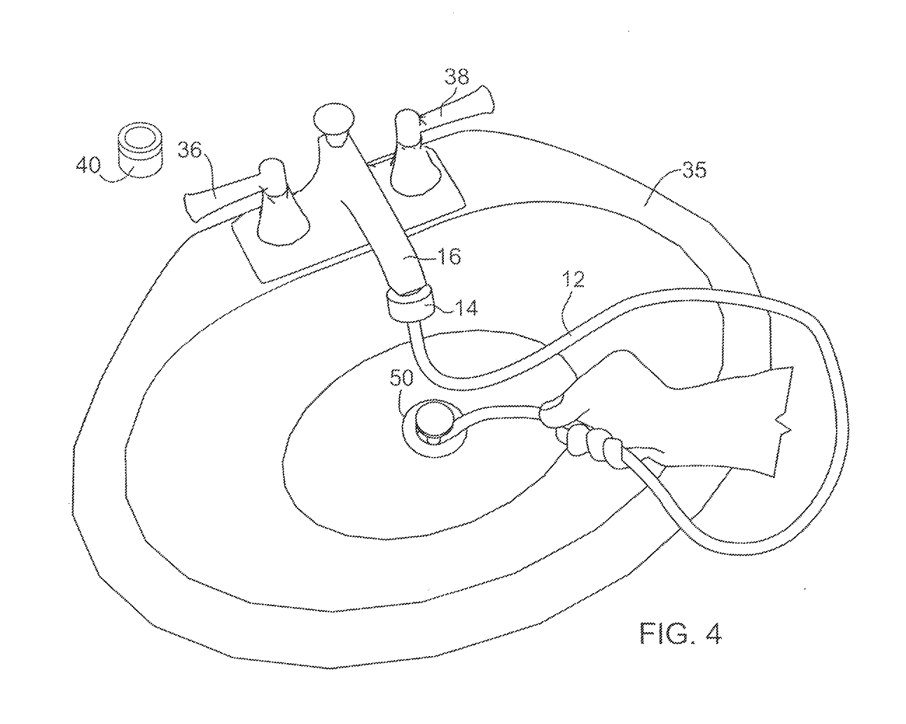

FIG. 1 illustrates a nozzle jet cleaning apparatus 10 which can be used to unplug drains, sink overflows and toilet bowl outlets and traps. The illustrated exemplary apparatus includes an elongate flexible hose 12 having an outside diameter of approximately ¼ inch and made of polyamide with polyester yarn reinforcement, this material having thermoformability and sufficient resistance to bending and kinking to permit the hose to be fed into a drain opening (as shown in FIG. 4) and along a drain passage. The cleaning apparatus includes a hose coupler 14 attached to one end of the hose 12 to permit connection thereof with a household source of pressurized water such as the sink faucet 16 shown in FIG. 4. The cleaning apparatus further includes a cylindrical metal nozzle 20 fixedly mounted inside an end section 22 of the hose at the other end of the hose located opposite the end 24. The nozzle has a central axial passage 26 extending the length of the nozzle member to a single front aperture 28 located at a front end of the nozzle. The axial passage is of uniform diameter and, in one exemplary embodiment, the diameter is about 1/16 inch. The front aperture 28 is located at the end 30 of the hose. During use of the cleaning apparatus 10, the hose is flexible and able to bend along substantially its entire length.

In an exemplary version of the nozzle, it is made of brass and is relatively short having a length of less than ¾ inch and a maximum diameter less than ¼ inch. In a particular exemplary embodiment, the brass nozzle has a length not less than ⅜ inch and not exceeding ½ inch and its outside diameter is about 3/16 inch. Mounting of the nozzle in the end of the tubing is done by a friction fit process. The nozzle 20 is forced into the end section of the tubing or hose 12 and this is facilitated by the application of heat to the tubing by boiling water. This heating process also improves the friction fit that holds the nozzle in the hose. Note that because of the material used for the tubing, normal household hot water will not stretch the tubing (and thus the nozzle cannot be ejected accidentally). Accidental ejection of the metal nozzle is also prevented by use of normal household faucet water pressure.

In the embodiment of the end section of the hose shown in FIG. 2, the end of the hose is cut perpendicular to its longitudinal axis as shown. However in another embodiment of the hose end section shown in FIG. 6, the annular end of the hose indicated at 32 is bevelled, that is cut at a 45 degree angle to the central axis of the nozzle. The bevel edge allows the leading edge of the cleaning apparatus to slide more easily over ridges in the drain and to better navigate turns in the drain.

The characteristics of the hose itself in an exemplary version of the cleaning apparatus add significantly to the usefulness of this tool. An exemplary hose is Synflex™ ¼ inch air brake tubing type A available from Eaton. This particular tubing meets SAE standard J844, has a hard, smooth exterior surface, and is made with 100% polyamide containing polyester yarn reinforcement. This tubing material has thermoformability which provides significant advantages over previously used tubing. The tubing has a minimum bend radius of 1 inch. Because this Synflex tubing is more rigid than tubing used previously for nozzle jet cleaning devices, it provides superior performance while the device is being fed into drain openings and through drain passages. Also the harder, glossier finish of this tubing reduces the friction between the tubing and the side of the drain as the tubing is being pushed into the drain. In addition, this high quality tubing provides longer service life and is less susceptible to bending and kinking.

Another advantageous feature of the exemplary cleaning apparatus 10 of the present disclosure is the relatively short nozzle 20 that is mounted by means of a friction fit in the end section of the tubing. Because the nozzle is relatively short, the cleaning apparatus is better able to navigate turns in the drain and is able to engage a blockage at close proximity. The thermoformability of the hose material allows the use of a short nozzle not exceeding ¼ inch in length.

FIG. 4 of the drawings illustrates the use of the cleaning apparatus 10 to unclog the drain of a sink 35 having the faucet 16 and two water control handles at 36 and 38. An exemplary form of the cleaning apparatus 10 can be provided with a three-in-one faucet connection adapter whose construction is known per se in the plumbing industry. This adapter enables the cleaning apparatus to be connected to almost all residential type faucets including the most common faucet type having a female 15/16^{th} inch connection and a less common type having a male 55/64 inch connection. A third type of faucet is a male garden hose (GH) commonly found on a laundry wash tub faucet. In order to connect the hose coupler 14 to either the first or second type of faucet, an aerator/screen assembly is first removed from the end of the faucet if one is present. This may require the use of pliers if the assembly is too tight to remove by hand. The aerator/screen assembly screen assembly for the sink of FIG. 4 is indicated at 40. Then one or two washers are inserted, into the hose coupler 14 (as required) and then the hose coupler 14 is connected to the end of the faucet by rotating the cylindrical coupler fitting 42 which can be provided with a series of spaced apart ridges 44 for gripping purposes. The hose coupler 14 is rotated counter-clockwise until finger tight.

In order to connect the illustrated coupler 14 to the type 3 faucet having the male garden hose (GH) thread, one first removes a stainless steel faucet adapter 46 from the outer coupler fitting 42 (which can be described as a female garden hose connector). This can be accomplished by holding the adapter 46 with pliers and turning the fitting or connector 42 counter-clockwise. It is, then possible to thread the fitting 42 onto the type 3 faucet.

After the nozzle jet cleaning apparatus has been connected to the sink faucet, the user can insert the nozzle end of the device into the drain opening, this opening being indicated at 50 in FIG. 4. The tube is pushed as far into the drain as possible by the user gripping the tube as shown. Then, by turning on the water tap to the fully opened position, a strong water jet can be applied to the drain blockage in order to break up and disburse the blockage. The present cleaning apparatus can also be used to clean out a bathroom sink overflow cavity by inserting the nozzle and its tube into the overflow opening and pushing the tube in as far as possible. The water from the faucet is then turned on and the cleaning apparatus is operated until the tube can be pushed into the overflow at least 6-8 inches or more. Dirty water will normally flow back out of the overflow opening until the overflow passageway is clear.

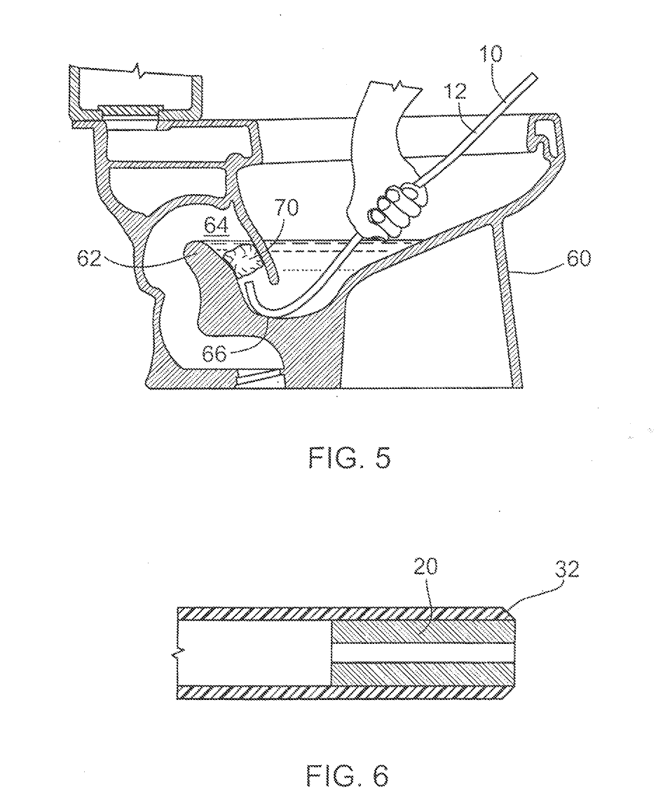

FIG. 5 illustrates another use for the nozzle jet cleaning apparatus 10. There is shown in this Fig. a vertical cross-section of a standard toilet bowl formed with a toilet outlet trap at 62. Again, prior to operating the cleaning apparatus the hose coupler 14 at one end of the flexible hose 12 is attached to a sink faucet or other available faucet in the area. The user then grabs the hose near its forward end as shown and inserts, an end section of the hose into the outlet duct 64. The hose will bend upwardly by the bottom 66 of the trap so the nozzle end is directed towards the obstruction or blockage 70. The fast moving, pressurized water exiting through the nozzle should break up and/or dislodge the obstruction 70 and push it over the hump of the toilet trap.

Although the cleaning apparatus can clear many forms of blockages in the toilet trap, it will not remove solid objects such as tools, toothbrushes, etc that may have fallen into the toilet bowl. The use of protective eyewear is recommended whenever the present cleaning apparatus is employed to clear a drain blockage. Assuming the pressurized water being used is hot water, this hot water when discharged from the nozzle can sometimes scald if it comes into contact with exposed skin. Also the sharp, high velocity jet of water created with the nozzle can cause injury to exposed humans and pets so a user should be careful as to where the high-velocity jet of water is directed.

While the present invention has been illustrated and described as embodied in an exemplary embodiment, e.g. an embodiment having particular utility unplugging drains, it is to be understood that the present invention is not limited to the details shown herein, since it will be understood that various omissions, modifications, substitutions and changes in the forms and details of the disclosed cleaning apparatus and its operation may be made by those skilled in the art, without departing in any way from the spirit and scope of the present invention.

Patents and publications mentioned in the specifications are indicative of the levels of those skilled in the art to which the invention pertains. These patents and publications are incorporated herein by reference to the same extent as if each individual application or publication was specifically and individually expressed explicitly in detail herein.

We claim:

1. A nozzle jet cleaning apparatus for unplugging drains, said apparatus comprising:
an elongate flexible hose having an outside diameter of approximately ¼ inch and being made of polyamide with polyester yarn reinforcement, said hose having sufficient resistance to bending and kinking to permit the hose to be fed into a drain opening and further into a drain passage;
a hose coupler attached to one end of the hose to permit connection thereof with a source of pressurized water;
a cylindrical metal nozzle fixedly mounted inside one end section of the hose at the other end of the hose located opposite said one end, said nozzle having a central axial passage extending the length of the nozzle to a single front aperture located at a front end of the nozzle, said axial passage being of uniform diameter along its length and said front aperture being located at said other end of the hose,
wherein during use of said cleaning apparatus, said hose is flexible and able to bend along substantially its entire length.

2. A cleaning apparatus according to claim 1 wherein said hose is constructed so as to have thermoformability and said metal nozzle is held inside said one end section of the hose by a friction fit.

3. A cleaning apparatus according to claim 1 wherein said metal nozzle is made of brass and has a length less than ¾ inch and a maximum diameter less than ¼ inch.

4. A cleaning apparatus according to claim 1 wherein said flexible hose is Synflex™ air brake tubing having a hard exterior surface.

5. A cleaning apparatus according to claim 3 wherein the brass nozzle has a length not less than ⅜ inch and not exceeding ½ inch and its central axial passage has a diameter of about 1/16^{th} inch.

6. A cleaning apparatus according to claim 1 wherein said other end of the hose is formed with a bevelled annular edge in order that said other end can slide more easily over a drain ridge.
